(19) United States
(12) Patent Application Publication
(10) Pub. No.: US 2010/0191665 A1
(43) Pub. Date: Jul. 29, 2010

(54) SERVICE VALUE CALCULATION METHOD, SYSTEM, AND PROGRAM

(75) Inventors: Kyoji Hirata, Tokyo (JP); Ken Hanazawa, Tokyo (JP); Masahiro Iwadare, Tokyo (JP)

Correspondence Address: Mr. Jackson Chen, 6535 N. STATE HWY 161, IRVING, TX, 75039, US

(73) Assignees: MONASH UNIVERSITY, Clayton, Victoria (AU); POLYCHIP PHARMACEUTICALS PTY LTD,, Toorak,, Victoria (AU)

(21) Appl. No.: 12/669,509

(22) PCT Filed: Jul. 10, 2008
(86) PCT No.: PCT/JP2008/062456

§ 371 Date: Jan. 18, 2010

(30) Foreign Application Priority Data
Jul. 19, 2007 (JP) 2007-187882

(51) Int. Cl. G06Q 10/00; G06Q 50/00

(52) U.S. Cl. 705/348; 705/400

(57) ABSTRACT

A service value calculation system includes: crisis problem inspection means which detects a crisis or a problem of a service object; and virtual damage amount calculation means which calculates a virtual damage amount generated if a detected crisis or problem is not solved when a service is not applied and calculates the service value.

### APPLICABLE FIELD IN THE INDUSTRY

The present invention relates to a technology of calculating a service value that is applied at the moment of providing a service, and more specifically to a service value calculation method, a system and a program for calculating a service value based upon a virtual damage amount that a user has avoided through the above service in a service for solving a crisis or a problem.

### BACKGROUND ART

In many conventional services, a service use charge that a user of various services pays to a service provider is set in a fixed manner by the service provider side similarly to the case of pricing commodities such as industrial goods.

One example of the method of adjusting the service use charge, which is collected from the user having received the service, to an appropriate amount responding to a quality of the actually provided service is described in Patent document 1. In the Patent document 1, an evaluation of each access point used in each use period is grasped based upon past operation result information, the total use times are calculated based upon this, and the service use charge is calculated.

As a technology of making the service price more persuasive, the method of evaluating an uncertain factor of the service as a risk and calculating the service price is described in Patent document 2. The Patent document 2 teaches that the uncertain factor such as the risk variation of the service is described as a probability model, the risk of the service provider is quantitatively evaluated, and the service effect that the user receives is estimated.

Further, Patent document 3 teaches the technique of calculating imperfections of system configuration information of a user system as a risk, notifying warning information to the user, and providing the service charge hereto.

Patent document 1: JP-P2002-329144A

Patent document 2: JP-P2006-227952A

Patent document 3: JP-P2005-099974A

### DISCLOSURE OF THE INVENTION

### Problems to be Solved by the Invention

However, in all of the conventional methods, the service price is set according to the piling-up of the provided costs set by the service provider, or the previous risk calculation. In the service providing method having such a cost piling-up technique, the following problems exist.

A first problem is that a feeling of persuasiveness cannot be obtained from the service user. The reasons thereof are listed below.

(1) An introduction effect of the service varies user by user, so a value criterion for the service varies user by user. Individual statuses of the users for these services are not reflected into the pricing system based upon the piling-up of the provided costs. In particular, in the case that the service user is an entrepreneur, not only a scale but also a profit status of the enterprise becomes a criterion for payment; however it is hard to reflect this into the current technique.

(2) The service providing price is inclined to become a fixed price, and hence, it is hard to reflect an effort for aiming for avoiding the problem such as an arrangement of the environment after introduction, which the user makes, into the service price.

A second problem is that it is hard for the service provider as well to obtain a feeling of persuasiveness. The reasons thereof is that, in the conventional method, when the service has been introduced once, it is hard to reflect the fruit (introduction result) achieved by the above service into the service amount of money. A desire etc. for expanding the service is hard to bring about after the introduction because the introduction result is not reflected into the amount of money.

Thereupon, the present invention has been accomplished in consideration of the above-mentioned problems, and an object thereof is to provide a service value calculation method, a system, and a program for realizing derivation of the service price that is persuasive to both of the service user and the service provider in the crisis avoidance service for solving/avoiding the crisis or the problem.

### Means to Solve the Problem

The present invention for solving the above-mentioned problem is a service value calculation method, comprising detecting a crisis or a problem of an object of a service, and calculating a service value, based upon a virtual damage amount that is generated when said crisis or problem has not been solved in a case where said service has not been applied, after having detected or solved the above crisis or problem.

The present invention for solving the above-mentioned problem is a service value calculation system, comprising: a crisis/problem detection means for detecting a crisis or problem of an object of a service; and a virtual damage amount calculation means for calculating a virtual damage amount that is generated when the detected crisis or problem has not been solved in a case where said service has not been applied, and calculating a value of said service.

The present invention for solving the above-mentioned problem is a program for calculating a service value, causing an information processing device to execute the processes of: detecting a crisis or problem of an object of a service; and calculating the service value based upon a virtual damage amount that is generated when said crisis or problem has not been solved in a case where said service has not been applied after having detected or solved said crisis and problem.

### AN ADVANTAGEOUS EFFECT OF THE INVENTION

An effect of the present invention is that the service price which is persuasive for service user can be set.

### BRIEF DESCRIPTION OF THE DRAWINGS

FIG. 1 is a block diagram of the service value calculation system in a first embodiment.

FIG. 2 is a block diagram illustrating one example of a crisis/problem detection means 1200.

FIG. 3 is a block diagram illustrating one example of a virtual damage amount calculation means 1400.

FIG. 4 is a view illustrating a flow of the process that is performed at the time of the problem/crisis avoidance service.

FIG. 5 is a view illustrating a flow of the process that is performed at the time of deciding the service price.

FIG. 6 is a block diagram of the service value calculation system in a second embodiment.

FIG. 7 is a view for explaining an example 1.

FIG. 8 is a view for explaining an example 2.

FIG. 9 is a view for explaining an example 3.

### DESCRIPTION OF NUMERALS

1100 information collection means
1200 crisis/problem detection means
1300 problem solving means
1400 virtual damage amount calculation means
1500 virtual damage history accumulation means
1600 service price calculation means
1700 service price output means

### BEST MODE FOR CARRYING OUT THE INVENTION

A first embodiment of the present invention will be explained.

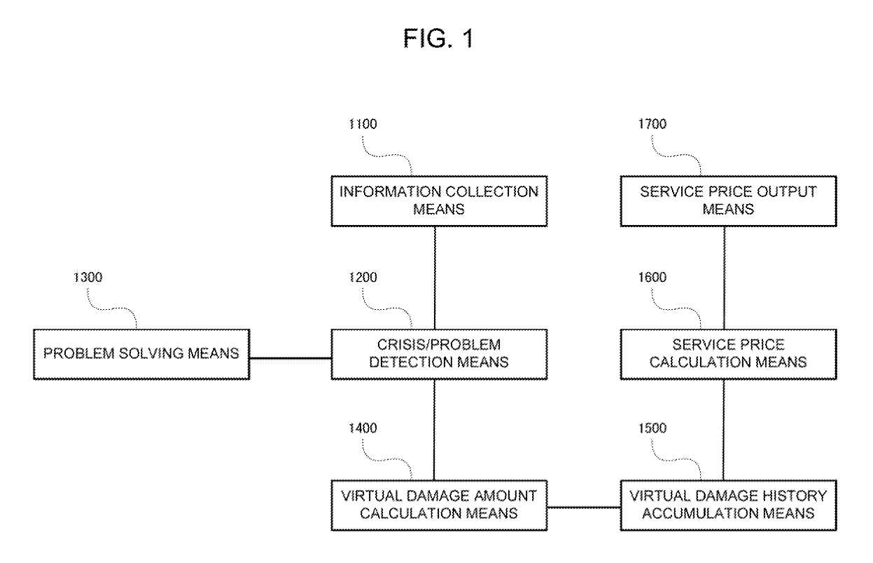

Upon making a reference to FIG. 1, the first embodiment of the present invention is comprised of an information collection means 1100 for collecting information of a target for a purpose of solving the problem, a crisis/problem detection means 1200 for detecting the crisis or the problem of the target based upon the collected information, a problem solving means 1300 for solving the detected crisis or problem, a virtual damage amount calculation means 1400 for calculating a virtual damage amount, which is generated when the crisis or the problem has not been solved, based upon the detected crisis and problem, a virtual damage history accumulation means 1500 for accumulating a history of the calculated virtual damage, a service price calculation means 1600 for calculating a service price based upon the accumulated history of the virtual damage, and a service price output means 1700 for outputting the calculated service price.

The information collection means 1100 collects various items of the information associated with the target in order to detect the problem of the target. Herein, the so-called target is a target for which the service is made, and, for example, when the content of the service is the securing of a safety of a certain predetermined area, the target is the above predetermined area, and further, when the content of the service is security of a certain computer system, the target is the above computer system. The information collection means 1100 is a means for collecting various items of the information associated with the target necessary for detecting the problem of such a target, and specifically, when the content of the service is the securing of a safety of a certain predetermined area, the information collection means 1100 is a combination of input appliances such as a camera for observing the above predetermined area and a microphone, and a sensor group for measuring temperature/humidity/brightness etc. of a room. Further, when the target is a specific computer system, the information collection means 1100 is a combination of various kinds of collection engines such as a collection engine of the history of a keyboard of the computer to which a connection has been made, a log information collection engine of a program that operates over the computer system, and a collection engine of an access log connected to or disconnected from the system. Additionally, the foregoing is very one example, and the information collection means 1100 could be a combination of various kinds of devices for measuring the matters necessary for solving the problem of the object.

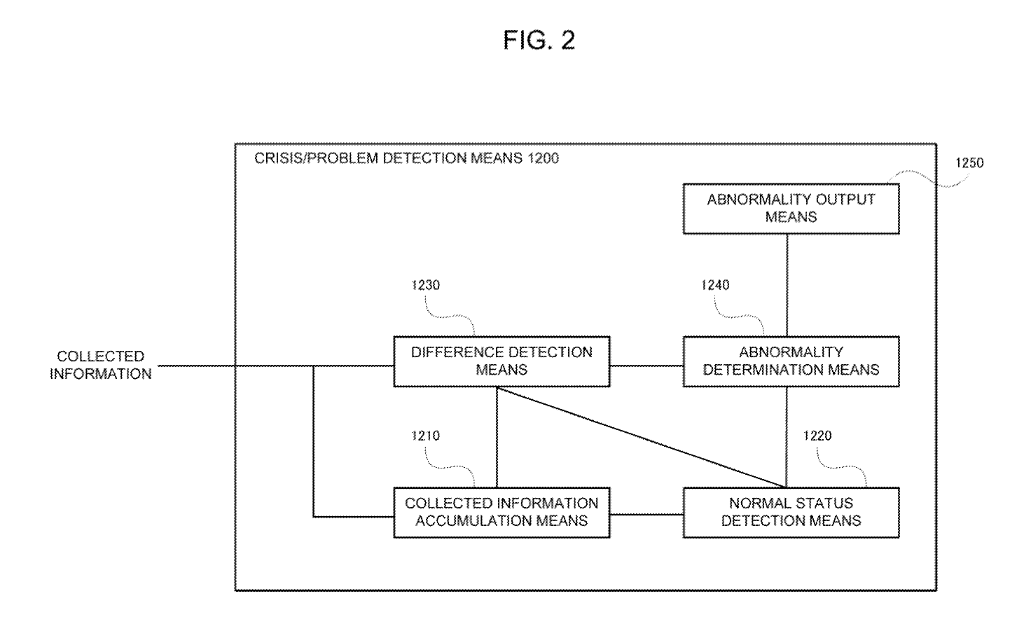

The crisis/problem detection means 1200 detects an abnormality and a dubious operation of the system based upon the collected information. One example of realizing the crisis/problem detection means 1200 is shown in FIG. 2. Herein, the crisis/problem detection means 1200 accumulates the collected information, detects a normal status of the target, and determines an abnormal status from a difference between the normal status and the current status. As a configuration for realizing this, the crisis/problem detection means 1200 is configured of a collected information accumulation means 1210 for accumulating the collected information, a normal status detection means 1220 for analyzing the collected information accumulated in the collected information accumulation means 1210, and detecting the normal status of the target, a difference detection means 1230 for detecting a difference between the normal status and the current status, an abnormality determination means 1240 for determining an abnormality based upon the foregoing difference information and normal status, and an abnormality output means 1250 for outputting detection of the abnormal status.

As one example of the collected information accumulation means 1210, there exists the storage device such as a hard disc/flash memory, and it does not matter that the collected information accumulation means 1210 is a dedicated accumulation device or is also used as another accumulation device.

Each of the difference detection means 1230, the abnormality determination means 1240, and the normal status detection means 1220, as one example, is a CPU having a program, which operates under a pre-decided rule, installed therein.

As one example of the abnormality output means 1250, a monitor for presenting a text or video, a loudspeaker for outputting sound, or the like can be listed; however the abnormality output means 1250 could be a CPU having a program including a message transmission function for making a notification to the other modules installed therein.

The problem solving means 1300, upon receipt of the crisis/problem detected by the crisis/problem detection means 1200, solves the problem. Various forms thereof are thinkable, depending upon the status of the target.

For example, when the content of the service is the securing of a safety of a certain predetermined area, the means having the mechanism such that an invasion of a suspicion person is prevented in connection with a lock mechanism of a door or a gate is thinkable as a solution of the problem. Further, with the case of the computer system, the problem solving means 1300 could be a CPU having such a program for seizing a document within the system infected with computer virus, which is to be transferred to the outside, and repairing the virus infection. Further, with the case of the system for detecting metal fatigue of the pipe etc. of the facilities or the like, a scheme of cooperation of the mechanism such as a robot arm for affixing a reinforcement member and a CPU for controlling it is thinkable. In addition, with the case of a file management, a combination of a disc for evacuating the relevant file upon receipt of the abnormal information of the disc, and a CPU having a program for executing the evacuation of the file built-in integrally is thinkable. With the case of the system for repairing imperfections associated with accounting, there exists the form of the CPU having a program for changing the contents of the file installed therein. Additionally, while the problem solving means is realized with a combination of a material for repairing a specific physical status, a mechanical scheme for the repair, a CPU for controlling them, and so on, the problem solving means may include the elements other than these.

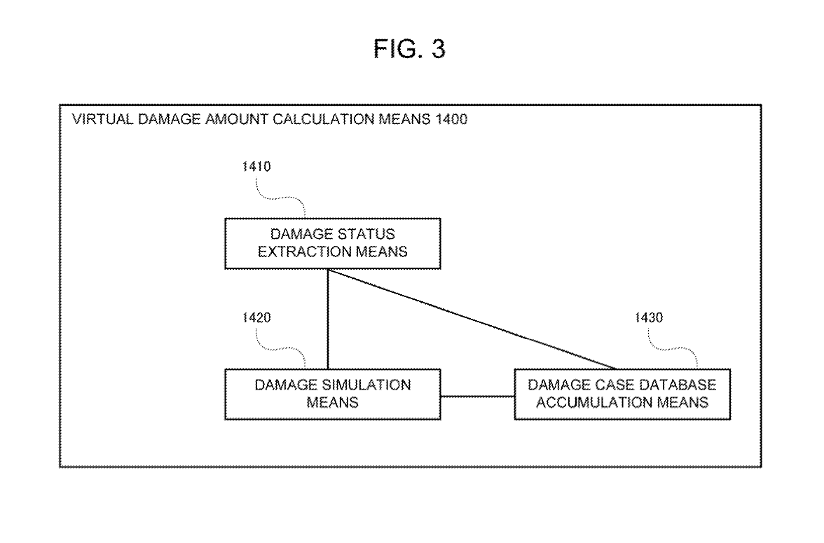

The virtual damage amount calculation means 1400 calculates the virtual damage amount based upon the crisis/problem detected by the foregoing crisis/problem detection means. One example of the virtual damage amount calculation means is shown in FIG. 3. Herein, the virtual damage amount calculation means 1400 is configured of a damage status extraction means 1410 for collecting the problem location and the status of its extent, a damage case database accumulation means 1430 for accumulating the relevant damage cases, and a damage simulation means 1420 for simulating the observed damage location and status of its extent by performing collation with the damage case database accumulation means 1430.

The damage case database accumulation means 1430 accumulates information associated with the similar damages. As one example of the damage case database accumulation means 1430, there exists the storage device such as a hard disc/flash memory, and it does not matter that the damage case database accumulation means 1430 is a dedicated accumulation device or is also used as another accumulation device. At the moment of constructing the damage case database, the user or the system operator may input data manually, thereby preparing the damage case database, and the damage case database accumulation means 1430 may include a network connection function to collect the information from Internet etc.

The damage status extraction means 1410, in cooperation with the damage case database accumulation means 1430, determines the damage location and the extent of the damage. When the virus countermeasure of the computer system is a target, the damage status extraction means 1410 detects the contents and the number of the infected files, and the contents and the number of the files that were due to flow out. Further, with the case of a transport system such as a pipe, the damage status extraction means 1410 determines a quantity of liquid/gas that gushes out to the outside.

The damage simulation means 1420, in cooperation with the damage status extraction means 1410 and the damage case database accumulation means 1430, simulates the damage status. The damage simulation means 1420 determines the virtual damage amount, which is generated if the efflux of the file occurs, in the case that the efflux of the file was prevented in the computer system, and determines the extent of the efflux and the damage to the outside, which are generated if a radioactive substance etc, flows out from the pipe, with a simulation. This technique, which is similar to the conventional technique that is employed for predicting the damage due to an earthquake, or the like, differs in a point that the origin which becomes a problem, for example, a breakage location of the pipe is specified in the beginning.

Additionally, the damage status extraction means 1410 can be packaged as a CPU having a function for analyzing a sensor and sensor information programmed therein. Further, the damage simulation means 1420 as well can be packaged as a CPU having a simulation program installed therein. The foregoing is very one example, and for example, for the calculation of the virtual damage amount, the method of successively investigating how the repaired file is used after the repair and calculating the virtual damage amount is also thinkable as another method.

The virtual damage history accumulation means 1500 accumulates the status associated with the virtual damage including the virtual damage amount calculated by the virtual damage amount calculation means 1400. Only the damage amount may be accumulated as information being accumulated, and the damage amount and the time as well as the status etc. may be recorded altogether. As one example of the virtual damage history accumulation means 1500, there exists the storage device such as a hard disc/flash memory, and it does not matter that the virtual damage history accumulation means 1500 is a dedicated accumulation device or is also used as another accumulation device.

The service price calculation means 1600 calculates the service price based upon the damage status accumulated in the foregoing virtual damage history accumulation means 1500. The service price may be calculated on the basis of a total of the damage amounts generated within a specific period in some cases, and the service price could be a price calculated by predicting the damage amount that will be generated within the specific period in the future, by taking a temporal effect into consideration, in some cases. As one example, the service price calculation means 1600 is a CPU having a program, which operates under a pre-decided rule, installed therein.

The service price output means 1700 outputs the service price calculated by the service price calculation means. As one example of the service price output means 1700, a monitor for presenting a text or video, a loudspeaker for outputting sound, or the like can be listed; however the service price output means 1700 could be a CPU having a program including a message transmission function for making a notification to the other modules installed therein.

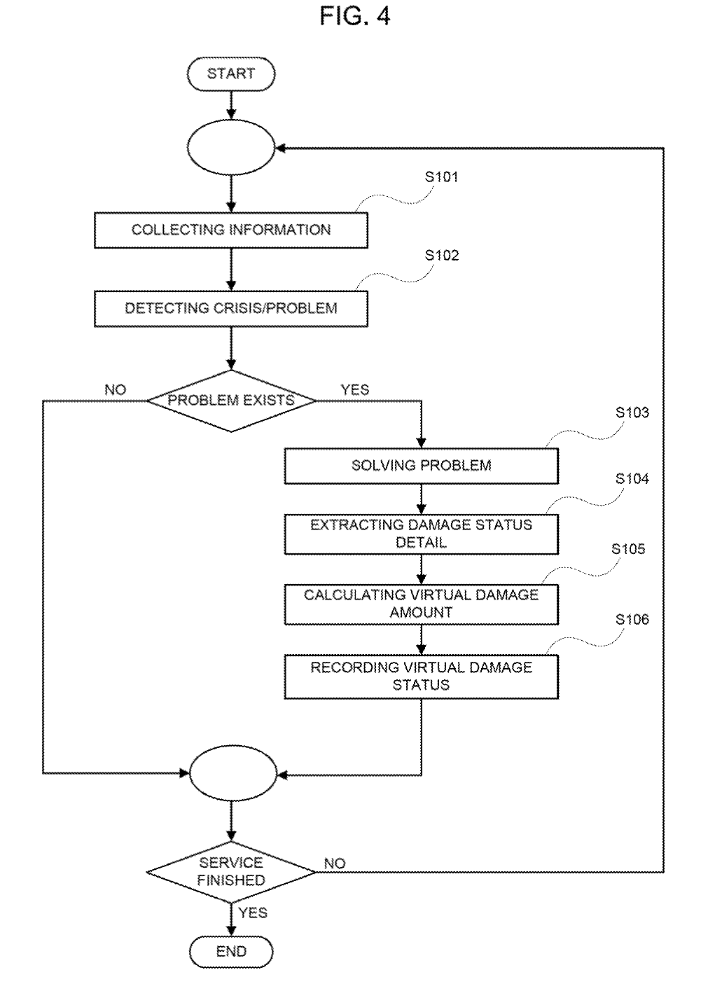

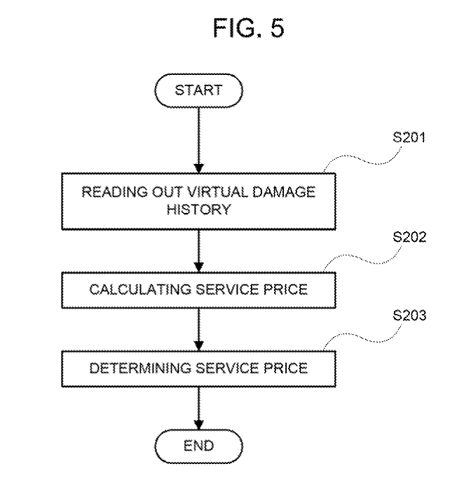

Next, an entire operation of this embodiment will be explained by making a reference to flowcharts of FIG. 1, FIG. 4, and FIG. 5.

FIG. 4 is a flowchart at the time of executing the normal problem/crisis management service.

The information collection means 1100 collects the relevant information for the object that becomes a target of detection or solution of the problem (step S101).

The crisis/problem detection means 1200 detects the crisis or the problem based upon the collected information (step S102). When the crisis or the problem has not been detected, the crisis/problem detection means 1200 finishes its operation without detection in a case where the service is finished, and collects the information in a case where the service is continued.

The problem solving means 1300 solves the crisis or the problem when the crisis or the problem has been detected (step S103).

The virtual damage amount calculation means 1400 extracts the details of the damage status (step S104), and calculates the virtual damage amount (step S105).

The virtual damage history accumulation means 1500 records the virtual damage status (step S106).

FIG. 5 shows a flow of calculating the service price.

The service price calculation means 1600 reads out the virtual damage history from the virtual damage history accumulation means 1500 (step S201), and calculates the service price (step S202).

The service price output means 1700 outputs the calculated service price (step S203).

An example in which the service price is calculated, for example, by calculating the virtual damage amount generated in the service period when the service period is finished, and multiplying this calculated virtual damage amount by a pre-decided ratio (for example, 20%) is thinkable. Further, the service price may be calculated by reading out the time of the virtual damage, predicting the virtual damage amount, which is generated in the next service period, from a temporal fluctuation in the damage amount, and multiplying this by a specific ratio. By doing so, the crisis/problem for the object of the service is avoided owing to the service, and the expenditure of the service user can be lowered to a minimum, for example, in such a manner that the service price is 20% of the virtual damage amount.

Such a price system enables the service user to execute an act of reducing the service price by performing various countermeasures after introducing the service, and reducing occurrence of the crisis or the problem during the period. Further, the service user can reduce payment of the service price to a lower level if no problem occurs fortunately even though he/she performs the operation with the risk held without taking the countermeasure for avoiding the crisis.

Further, lowering the service price, which is applied when no problem occurs, to zero or a very low level makes it possible to reduce the burden of the user at the time of starting the service and to promote the service introduction.

The point in which this embodiment differs from the conventional insurance technique is very this point. Upon placing oneself in the service provider side' place, the problem stochastically occurs in the long run, so an increase in the number of the service subscribers can lead to an expansion of the sales of the service price, and this embodiment holds as a service.

A second embodiment of the present invention will be explained in details by making a reference to the accompanied drawings.

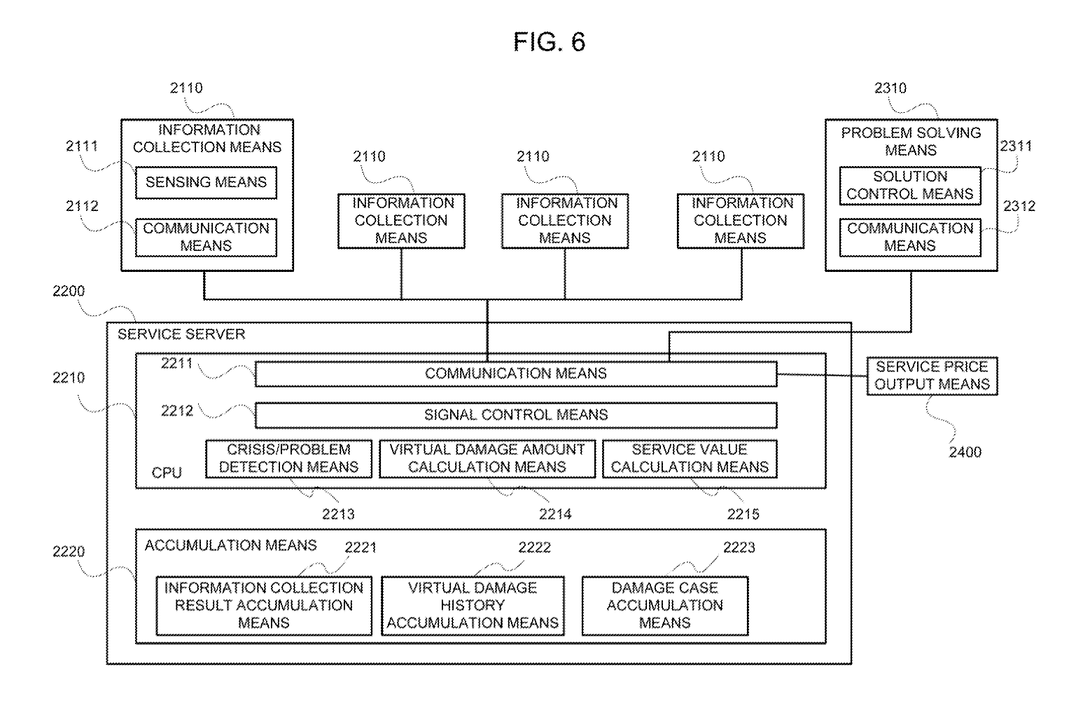

Upon making a reference to FIG. 6, the second embodiment of the present invention is configured of a plurality of information collection means 2110 for collecting information of the target for a purpose of extracting or detecting the problem, a service server 2200 for collecting and accumulating the information, and detecting/outputting the problem from the collected/accumulated information, a problem solving means 2310 for solving the problem based upon the detected problem, and a service price output means 2400 for outputting the service price.

Each of a plurality of the information collection means 2110 is configured of a sensing means 2111 for extracting the status of the target, and a communication means 2112 for transmitting the extracted information to the service server. Additionally, the sensing means 2111 is a sensing appliance such as a microphone, a thermometer, and a camera as one example.

The service server 2200 is configured of a CPU 2210 for executing a program, and an accumulation means 2220 for accumulating the information.

As one example of the accumulation means 2220, there exists the storage device such as a hard disc/flash memory, and it does not matter that the accumulation means 2220 is a dedicated accumulation device or is also used as another accumulation device.

The CPU 2210 is configured of a communication means 2211 for supporting communication with the outside such as the information collection means 2110 and the problem solving means 2310, a crisis/problem detection means 2213 for detecting the crisis or the problem from the information for the target accumulated in an information collection result accumulation means 2221, a virtual damage amount calculation means 2214 for calculating the virtual damage amount by collating the extracted problem with the damage case accumulated in a damage case accumulation means 2223, a service value calculation means 2215 for calculating the service value based upon the virtual damage history, and a signal control means 2212 for control them. Additionally, each component is configured of a CPU having a program, which operates under a pre-decided rule, installed therein as one example.

The accumulation means 2220 is configured of the information collection result accumulation means 2221 for accumulating the information collected from the target for a purpose of solving the problem, a virtual damage history accumulation means 2222 in which the virtual damage history outputted by the virtual damage amount calculation means 2214 is accumulated, and the damage case accumulation means 2223 in which the damage case for calculation of the virtual damage amount is accumulated.

The problem solving means 2310 is configured of a communication means 2312 for making communication with the service server, and a solution control means 2311.

As the solution control means 2311, for example, the mechanism such that an invasion of a suspicion person is prevented in connection with a lock mechanism of a door or a gate is thinkable. Further, with the case of the computer system, the solution control means 2311 could be a CPU having such a program for seizing a document within the system infected with computer virus, which is to be transferred to the outside, and repairing the virus infection. With the case of the system for detecting metal fatigue of the pipe etc. of the facilities or the like, a scheme of cooperation of the mechanism such as a robot arm for affixing a reinforcement member and a CPU for controlling it is thinkable. In addition, with the case of a file management, a combination of the disc for evacuating the relevant file upon receipt of the abnormal information of the disc, and the CPU having a program for executing the file evacuation integrally built-in is thinkable. With the case of the system for repairing imperfections associated with accounting, there exists the form of the CPU having a program for changing the contents of the file installed therein.

Additionally, while the problem solving means 2310 is realized with a combination of a material for repairing a specific physical status, a mechanical scheme for the repair, a CPU for controlling them, and so on, the problem solving means 2310 may include the elements other than these.

As one example of the service price output means 2400, a monitor for presenting a text or video, a loudspeaker for outputting sound, or the like can be listed; however the service price output means 2400 could be a CPU having a program including a message transmission function for making a notification to the other modules installed therein.

As mentioned above, a first effect of the embodiment of the present invention is that the service price which is persuasive for the service user can be set. The reason for it is listed below.

1) The price calculation based upon the virtual damage amount, being the actual effect owing to the introduction of the service, is enabled. Further, linking the price calculation to the virtual damage amount makes it possible to reflect the scale/profit status of the service user into the service price.

2) An effort being made in the service user side enables an expectation value of the detection of the problem/crisis to be lowered, and an effort by the user is easily reflected in into the service price.

Further, a second effect of the embodiment of the present invention is that the service price which is persuasive for the service provider can be set. The reason is that performing the problem avoidance or the crisis detection without omission makes it possible to enhance the service price. Setting the persuasive price urges the service provider to raise a desire for improving the service.

### Example 1

The example 1 of the present invention will be explained.

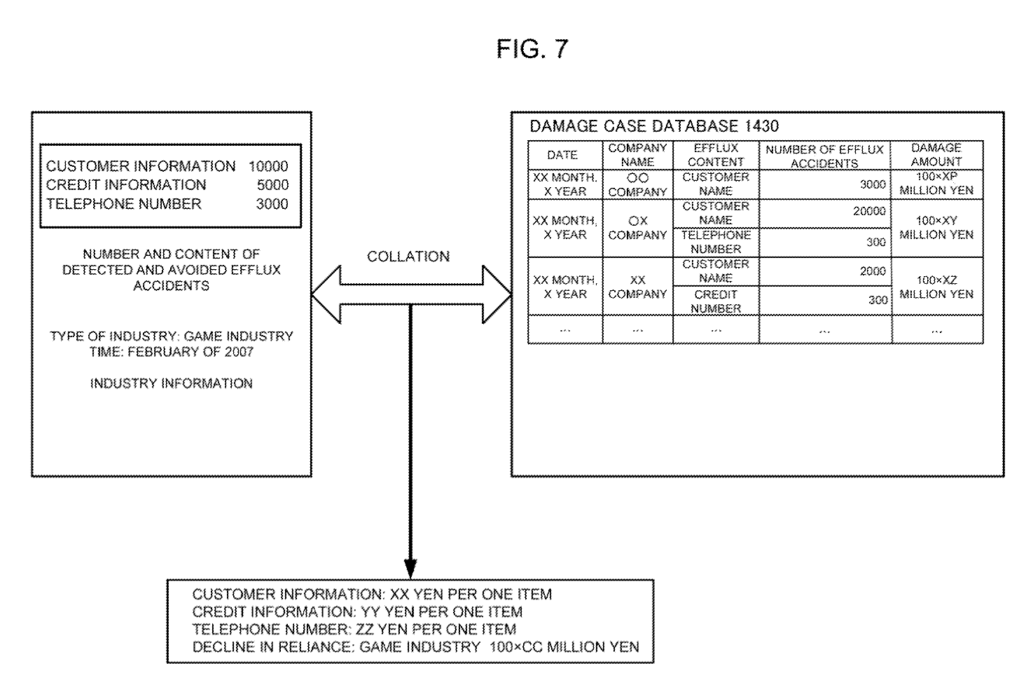

FIG. 7 is a view illustrating one example of the calculation of the service price that is applied at the moment of the efflux of the file due to the computer virus.

The contents of the past efflux accidents of the file and the damage amounts due to them are accumulated in a damage case database accumulation means 1430. When the problem has been detected, the file that was due to actually flow out can be specified, whereby a damage status extraction means 1410 makes a reference to the file, and specifies the number of the items and the contents of the personal information.

A damage simulation means 1420 performs collation with the damage case database 1430 based upon the status of the virtual damage (in FIG. 7, the number of the items of customer information is 10000, the number of the items of credit information is 5000, and the number of telephone numbers is 3000), the business information and the time, calculates the damage amount per one item of the customer information, the credit information, the telephone number, etc. based upon the business, the time, the scale, etc., and calculates the virtual damage amount.

And, the service prides is calculated by multiplying the virtual damage amount by a pre-decided ratio (20%). The service price in this example becomes ((10000×XX)+(5000×YY)+(3000×ZZ)+CC)×0.2 yen.

### Example 2

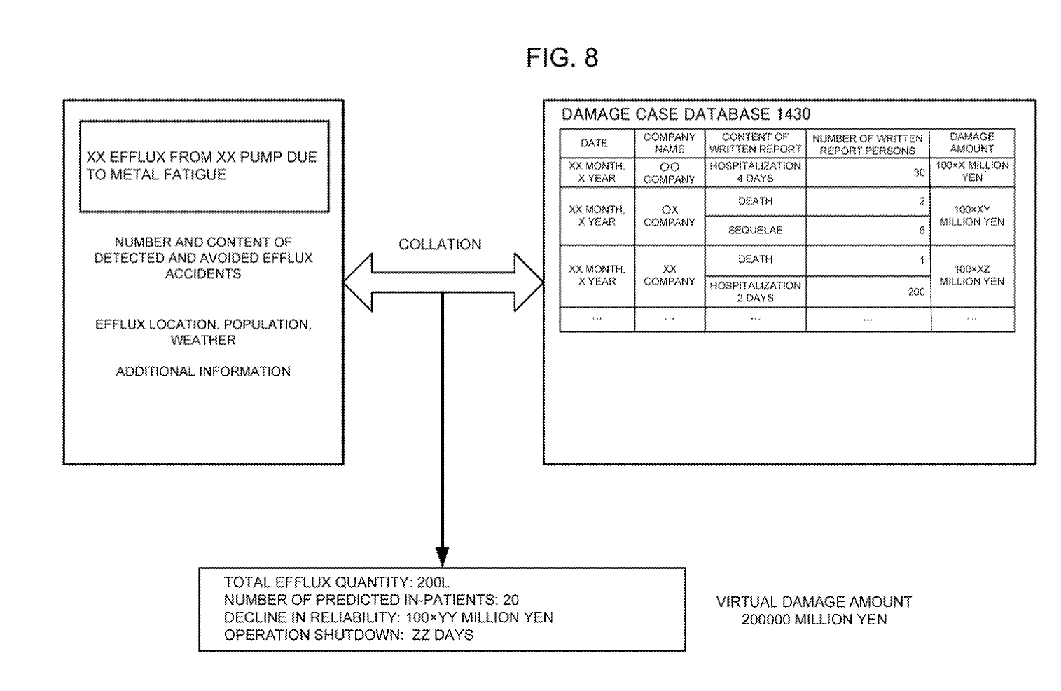

FIG. 8 is a view illustrating one example of the calculation of the service price that is applied at the moment that the leakage of a poisonous substance is detected in a factory.

The statuses of the various damages of the similar matter such as the number of the in-patients and the deceased, and the number of days of shutdown of the operation are stored in the damage case database accumulation means 1430. When the breakage in a specific location of the pipe has been detected and repaired automatically, the efflux quantity of the poisonous substance that flowed out, and the damage amount due to it can be calculated from the breakage location of the pipe, the operation status, the weather and the time of the appointed day, and the population in the adjacent. The virtual damage amount is calculated in terms of the production amount of the similar accident that occurred in the past. In this example, the virtual damage amount is 200 billion yen.

And, the service price is calculated by multiplying the virtual damage amount by a pre-decided ratio (20%). The service price in this example is 200 billion yen×0.2=4 billion yen.

### Example 3

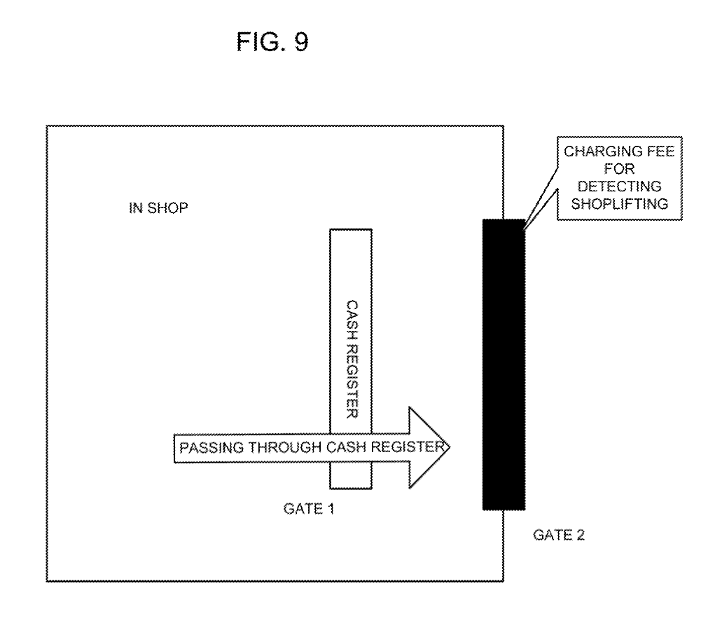

FIG. 9 is a view illustrating one example of the calculation of the service price that is applied for the service for preventing shoplifting.

When a culprit passes through a gate 1carrying commodities without settling the accounting at a cash register and goes out from a shop, the shoplifting is detected at a gate 2 and the culprit is urged to pay money. In this case, the virtual damage amount becomes a sum of the prices of the shoplifted commodities.

For example, when a total amount of the commodities is 10000 yen, the service price in this time is 10000×0.2=400 yen when the pre-decided ratio is 20%.

In the foregoing examples, the typical examples were listed. The direct calculation of the damage amount and the calculation of the damage amount correspondingly to the case collection can be easily performed because the status in which the damage is due to occur (the failure location, the efflux position, the shoplifted commodity, and the tool that was due to be destroyed) can be accurately inputted as an input owing to the problem detection.

With the similar method, the virtual damage amount can be calculated by use of the similar means in the crisis/problem detection of various types besides the detection of illegal transaction in the Internet, fire prevention, and anti-theft.

The 1st invention inventions is characterized in that a service value calculation method, comprising detecting a crisis or a problem of an object of a service, and calculating a service value, based upon a virtual damage amount that is generated when said crisis or problem has not been solved in a case where said service has not been applied, after having detected or solved the above crisis or problem.

The 2nd invention in the above-mentioned 1st invention is characterized in that the service value calculation method comprising calculating a service price being provided to a user based upon said calculated service value.

The 3rd invention in the above-mentioned 1st invention is characterized in that said virtual damage amount is calculated with a simulation based upon the detected crisis or problem.

The 4th invention in the above-mentioned 1st invention is characterized in that a similar example resembling the actually detected crisis or problem, and this damage amount are retrieved from a case database associated with the pre-accumulated crisis or problem, and said virtual damage amount is calculated based upon the above similar example and damage amount.

The 5th invention in the above-mentioned 1st invention is characterized in that said virtual damage amount is calculated based upon a frequency of utilization of a location repaired within a constant period after repairing the problem.

The 6th invention in the above-mentioned any one of 2nd to 5th inventions is characterized in that said service price is calculated by multiplying a total of the virtual damage amounts generated in a specific period by a pre-decided value.

The 7th invention in the above-mentioned any one of 2nd to 5th inventions is characterized in that said service price is calculated based upon the virtual damage amount generated in a specific period, and a prediction value of the virtual damage amount that will be generated in a specific period in the future based upon the time at which the virtual damage has occurred.

The 8th invention is characterized in that a service value calculation system, comprising: a crisis/problem detection means for detecting a crisis or problem of an object of a service; and a virtual damage amount calculation means for calculating a virtual damage amount that is generated when the detected crisis or problem has not been solved in a case where said service has not been applied, and calculating a value of said service.

The 9th invention in the above-mentioned 8th invention is characterized in that said service value calculation system comprising a service price calculation means for calculating the service price being provided to a user based upon said virtual damage amount.

The 10th invention in the above-mentioned 8th invention is characterized in that said virtual damage amount calculation means calculates the virtual damage amount with a simulation based upon the detected crisis or problem.

The 11th invention in the above-mentioned 8th invention is characterized in that said virtual damage amount calculation means retrieves a similar example resembling the actually detected crisis or problem, and this damage amount from a case database associated with the pre-accumulated crisis or problem, and calculates the virtual damage amount based upon the above similar example and damage amount.

The 12th invention in the above-mentioned 8th invention is characterized in that said virtual damage amount calculation means calculates the virtual damage amount based upon a frequency of utilization of a location repaired within a constant period after repairing the problem.

The 13th invention in the above-mentioned any one of 9th to 12th inventions is characterized in that said service price calculation means calculates the service price by multiplying a total of the virtual damage amounts generated in a specific period by a pre-decided value.

The 14th invention in the above-mentioned any one of 9th to 12th inventions is characterized in that said service price calculation means calculates the service price based upon the virtual damage amount generated in a specific period, and a prediction value of the virtual damage amount that will be generated in a specific period in the future based upon the time at which the virtual damage has occurred.

The 15th invention is characterized in that a program for calculating a service value, causing an information processing device to execute the processes of: detecting a crisis or problem of an object of a service; and calculating the service value based upon a virtual damage amount that is generated when said crisis or problem has not been solved in a case where said service has not been applied after having detected or solved said crisis and problem.

The 16th invention in the above-mentioned 15th invention is characterized in that said causing the information processing device to execute a process of calculating a service price being provided to a user based upon said calculated service value.

Above, while the present invention has been described with respect to the preferred embodiments and examples, the present invention is not always limited to the above-mentioned embodiment and examples, and alterations to, variations of, and equivalent to these embodiments and the examples can be implemented without departing from the spirit and scope of the present invention.

This application is based upon and claims the benefit of priority from Japanese patent application No. 2007-187882, filed on Jul. 19, 2007, the disclosure of which is incorporated herein in its entirety by reference.

### HOW THE INVENTION IS CAPABLE OF INDUSTRIAL EXPLOITATION

This service is applicable as a tool for effectively setting the price that is applied for the service for solving the crisis or the problem. By enhancing a precision of the virtual damage amount, this service is applicable to the service of the problem avoidance or the crisis avoidance of all production activities such as a computer system, a plant, a traffic system, and an enterprise activity.

1. A service value calculation method, comprising detecting a crisis or a problem of an object of a service, and calculating a service value, based upon a virtual damage amount that is generated when said crisis or problem has not been solved in a case where said service has not been applied, after having detected or solved the above crisis or problem.

2. A service value calculation method according to claim 1, comprising calculating a service price being provided to a user based upon said calculated service value.

3. A service value calculation method according to claim 1, wherein said virtual damage amount is calculated with a simulation based upon the detected crisis or problem.

4. A service value calculation method according to claim 1, wherein a similar example resembling the actually detected crisis or problem, and this damage amount are retrieved from a case database associated with the pre-accumulated crisis or problem, and said virtual damage amount is calculated based upon the above similar example and damage amount.

5. A service value calculation method according to claim 1, wherein said virtual damage amount is calculated based upon a frequency of utilization of a location repaired within a constant period after repairing the problem.

6. A service value calculation method according to claim 2 wherein said service price is calculated by multiplying a total of the virtual damage amounts generated in a specific period by a pre-decided value.

7. A service value calculation method according to claim 2 wherein said service price is calculated based upon the virtual damage amount generated in a specific period, and a prediction value of the virtual damage amount that will be generated in a specific period in the future based upon the time at which the virtual damage has occurred.

8. A service value calculation system, comprising:
a crisis/problem detector that detects a crisis or problem of an object of a service; and
a virtual damage amount calculator that calculates a virtual damage amount that is generated when the detected crisis or problem has not been solved in a case where said service has not been applied, and calculates a value of said service.

9. A service value calculation system according to claim 8, comprising a service price calculator that calculates the service price being provided to a user based upon said virtual damage amount.

10. A service value calculation system according to claim 8, wherein said virtual damage amount calculator calculates the virtual damage amount with a simulation based upon the detected crisis or problem.

11. A service value calculation system according to claim 8, wherein said virtual damage amount calculator retrieves a similar example resembling the actually detected crisis or problem, and this damage amount from a case database associated with the pre-accumulated crisis or problem, and calculates the virtual damage amount based upon the above similar example and damage amount.

12. A service value calculation system according to claim 8, wherein said virtual damage amount calculator calculates the virtual damage amount based upon a frequency of utilization of a location repaired within a constant period after repairing the problem.

13. A service value calculation system according to claim 9, wherein said service price calculator calculates the service price by multiplying a total of the virtual damage amounts generated in a specific period by a pre-decided value.

14. A service value calculation system according to claim 9, wherein said service price calculator calculates the service price based upon the virtual damage amount generated in a specific period, and a prediction value of the virtual damage amount that will be generated in a specific period in the future based upon the time at which the virtual damage has occurred.

15. A recording medium in which a program for calculating a service value, wherein said program causes an information processing device to execute the processes of:
detecting a crisis or problem of an object of a service; and
calculating the service value based upon a virtual damage amount that is generated when said crisis or problem has not been solved in a case where said service has not been applied after having detected or solved said crisis and problem.

16. A recording medium according to claim 15, wherein said said program causes the information processing device to execute a process of calculating a service price being provided to a user based upon said calculated service value.
